(19) United States
(12) Patent Application Publication
(10) Pub. No.: US 2014/0130322 A1
(43) Pub. Date: May 15, 2014

(54) Ready To Assemble Modular Upholstery

(71) Applicant: Roger Allen Helton, Hickory, NC (US)

(72) Inventor: Roger Allen Helton, Hickory, NC (US)

(21) Appl. No.: 14/079,602

(22) Filed: Nov. 13, 2013

Related U.S. Application Data
(60) Provisional application No. 61/725,534, filed on Nov. 13, 2012.

(51) Int. Cl. B68G 13/00

(52) U.S. Cl. CPC B68G 13/00
USPC 29/91.1

(57) ABSTRACT

Modular ready to assembly furniture consists of components when assembled will embody a chair, sofa, loveseat or sofa sectional.

These modular components include arm component and back component. The arm component having a bolt, consisting of a large round head protruding from the inside p [symbol] of the arm. The back component having a keyhole slot along the side consisting of a internal tapered ramp. The head of the bolt fits through this keyhole slot. Thus the hea [symbol] the bolt slides up the tapered ramp. This action pulls together both components. Wher [symbol] fully seated the arm component and back component is held together at a precise and matching location.

The new unique feature is the upper connection of the preferred embodiment that connects the arm and back. It is completely hidden after assembly and adjust for variances in materials and manufacturing. This special adjustable connector allows for quick self tightening engagement and precision alignment of the back and arms.

### CROSS-REFERENCE TO RELATED APPLICATIONS

In Part of claims benefit of Provisional Application number 61725534 Filing date: Nov. 13, 2012

### FEDERALLY SPONSORED RESEARCH

NA

### SEQUENCE LISTING

NA

### BACKGROUND OF THE INVENTION

RTA or ready to assemble products are very common items found in the current market place. For manufacturing and shipping large items the advantages and cost savings of RTA is widely accepted. Finished wood or casegoods furniture is no exception. However, currently furniture customers and retailers still face challenges finding and purchasing quality RTA upholstered furniture. The invention of this special connector and the use of more standard type connectors for assembling the different components as described will solve this problem.

Upholstered furniture usually consists of seat, back and arms in various shapes and sizes. A frame consisting of these parts is joined together using staples, wood dowels and/or glue. This frame moves through manufacturing in stages adding supporting material, springs, padding and covered in upholstery materials as a single large unit. Then packaged for shipping. A much more efficient method is to manufacture individual components through an assembly line designed for that component. Each component will be packaged together using much less space, thus saving substance-sully on shipping, handling and warehousing costs. Assembling together the components using this special connections and metal brackets and bolts provide a much stronger frame. This compared to standard manufacturing methods using staples, wood dowels and/or glue. Quality ready to assemble upholstery requires that each component to completely covered or upholstered and finished. After assembly and sitting upright their should be no visual signs of connectors and no gaps or movement between any parts. The style, design and comfort should not be limited to only one or two choices. Previous attempts at ready to assemble upholstery has not been able to address all these issues. Their are three major points of connection or stress areas of where the resting arm attaches to the back in a standard upholstered frame. This embodiment addresses these areas that has been very problematic in ready to assemble components. These areas will be described and shown in greater detail in the drawings and detailed summary of the said embodiment.

### BRIEF DESCRIPTION OF THE DRAWINGS

FIG. 1 shows an exploded front perspective view of one embodiment of the chair in accordance with the invention. The seat and backrest cushions have been removed as to provide a clearer view of the said embodiment.

FIG. 2 is a perspective view of the backside of the chair. Thus showing the right side arm component 2 and the back component 1. The back component is shown as a wireframe with the exception of the internal back post 12 show as a solid part.

FIG. 3 is an enlarged view from FIG. 2 showing the internal back post 12 within back component 1 assembled to the arm component 2.

FIG. 4 shows from FIG. 3 the plane in which the cross sectional view is taken in the following FIG. 5.

FIG. 5 is a cross sectional view of arm component 2 and the internal back post 12 within back component 1. Thus illustrating the assembly motion of said invention.

FIG. 5A is a cross sectional view showing the motion of assembly of said invention.

FIG. 5B is a cross sectional view showing the completed motion of assembly of said embodiment.

### DESCRIPTION OF THE PREFERRED EMBODIMENT

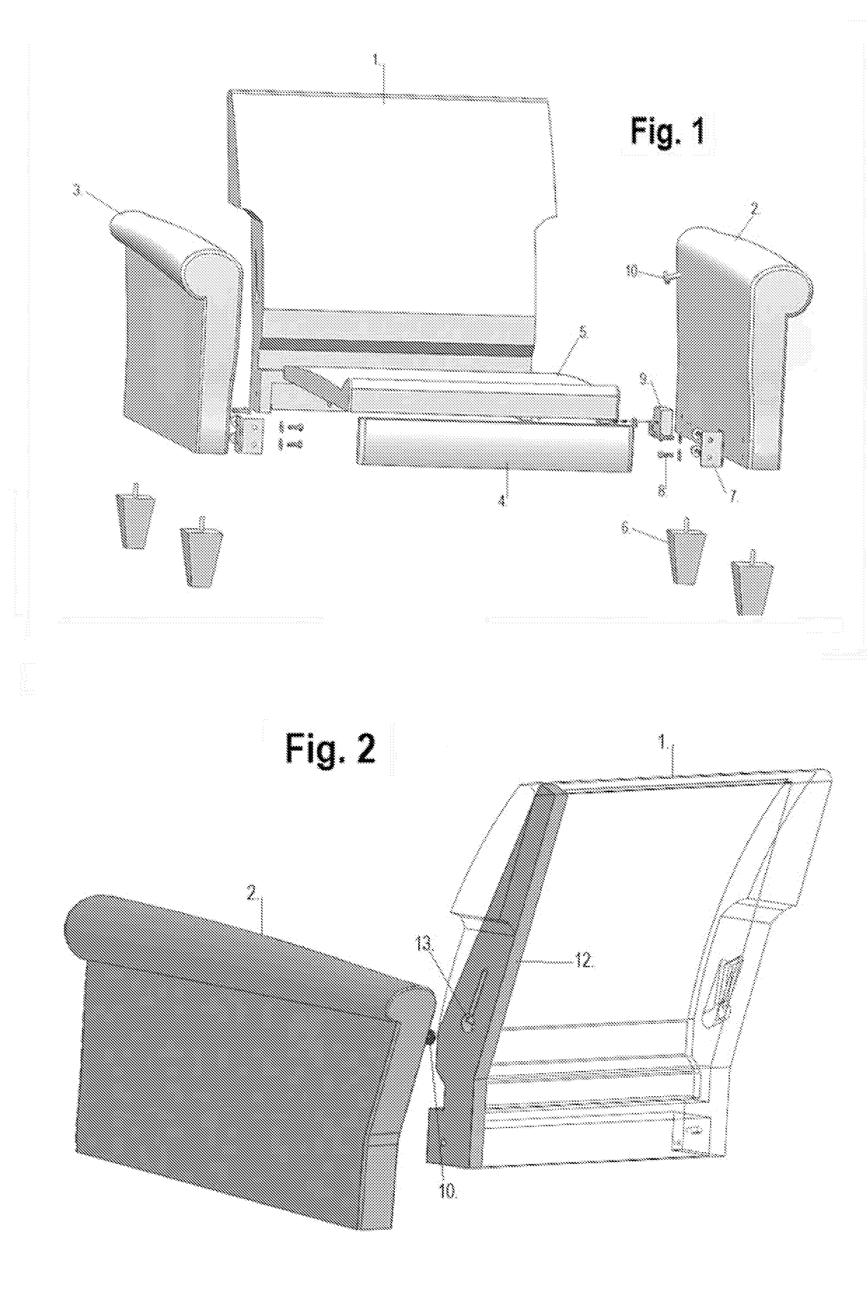

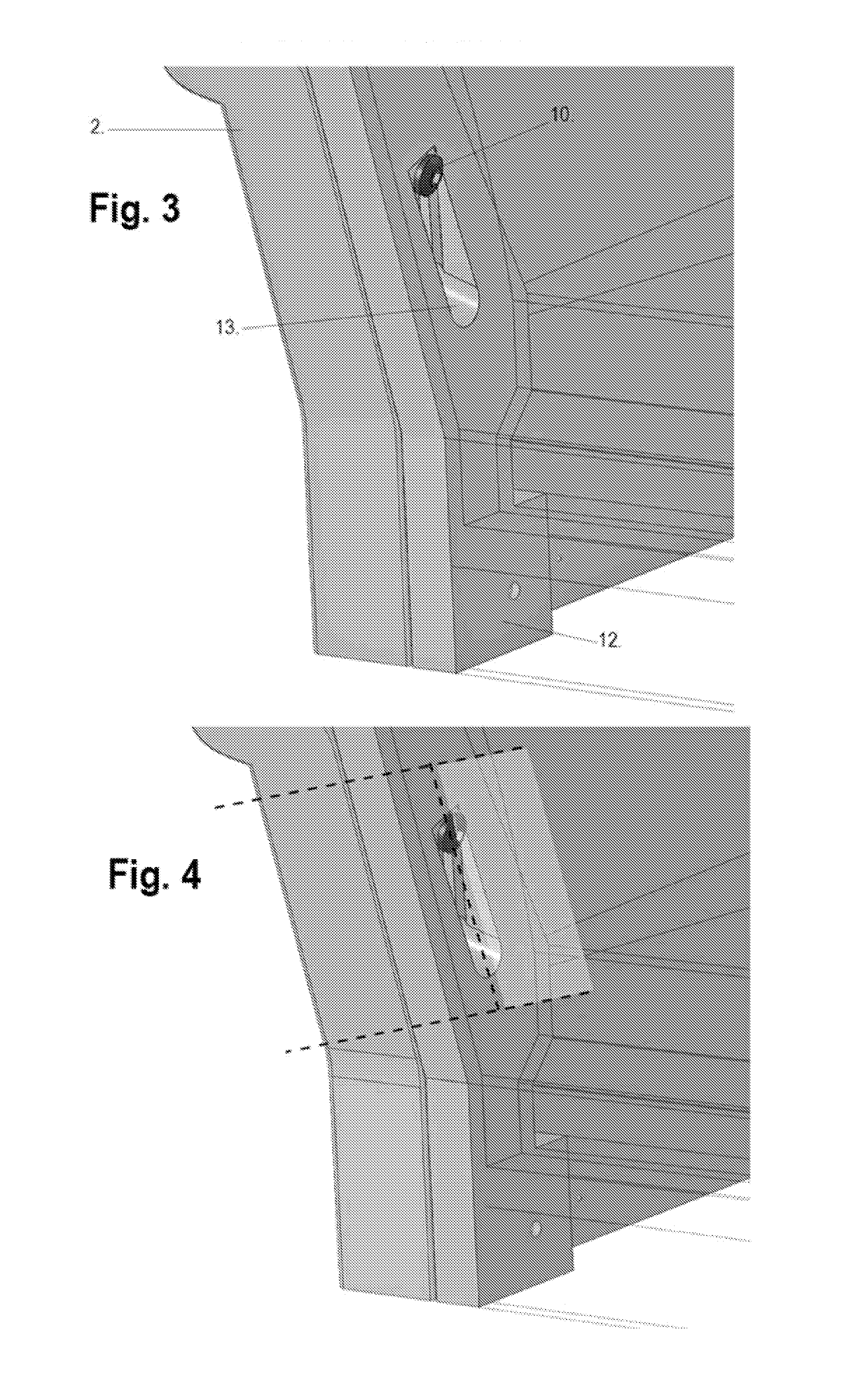

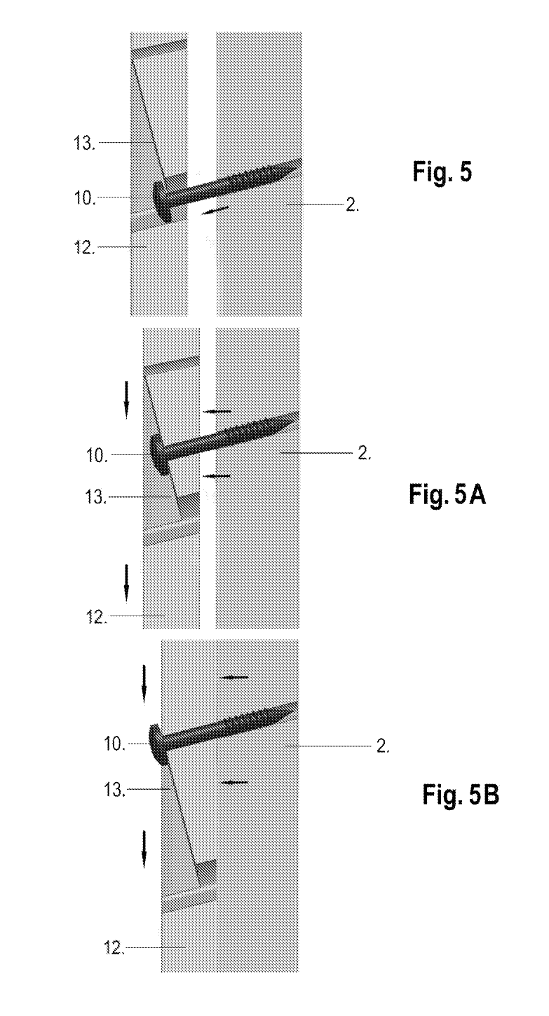

With reference to FIG. 1, this is an illustrated exploded view of a chair embodying the present invention. While this is one embodiment of said invention, that is should be know that the invention is equally applicable to sofas and or any other item of seating furniture that includes but not limited to a seat, arm rest and back rest. The chair comprises of components, back 1, right arm 2, left arm 3, seat rail 4, seat deck 5, legs 6, metal parts 7-8, guide block 9, and connecting bolt 10, mounted into components arm 2-3. The components 1-6 can be built from wood or engineered wood, plastics and any other materials of sufficient strength. These components can also be covered in any suitable materials of fabrics, leathers or natural fibers. Referring now to FIG. 2 showing components back 1 and right arm 2. The component back 1 is shown in a perspective wire frame illustrating the internal part back post 12. With back post 12 is shown as a solid part to better illustrate the assembly process of the said invention. In the process of assembly the component arm 2, with connecting bolt 10 is inserted into the keyhole 13 of the component back 2. The keyhole is one aspect of named 13 keyhole slot, this keyhole which also includes an internal tapered ramp of which all is mechanically machined into the part back post 12. This insertion of connecting bolt 10 into the machined slot 13, in which the head of the said bolt sliding up the machined ramp and results will be fully described hereafter. Referring now to FIG. 3 showing the final result of the connecting bolt 10 into the machined slot 13 of which is an integral part of the back post 12. The results as shown in FIG. 3 is a mechanical engagement of component arm 2 with component back 1. To better illustrate this mechanical motion of engagement, a cut-away sectional view of the machined slot 13 is required. The illustrated plane of the cut-away sectional view is shown if FIG. 4. Referring now to FIG. 5 illustrating the sectioned plane of component arm 2 and part back post 12. This illustrated plane cuts vertically through the center length of machined slot 13, as shown previously in FIG. 4. The part connecting bolt 10 of which is screwed into component arm 2 in a predetermined spot at the correct angle that is precisely of the same angle and degree cut of the machined ramp 13 in part back post 12. This precision fit allows the bottom surface of the screw head of part connecting bolt 10 to slide along the ramped path of the machined slot 13. Inserting the part connecting bolt 10 into the keyhole of the machined slot 13, as shown by the arrow in FIG. 5, begins with sufficient space between component arm 2 and component back 1. As shown if FIG. 5A, the downward motion push of the part back post 12, as shown by the vertical arrows, allows the part connecting bolt 10 to slide along the machined ramp 13. The sliding of the part connecting bolt 10 along the machined path 13, will bring together the component arm 2 and the component back 1, as shown by the horizontal arrows in FIG. 5A and FIG. 5B. As shown if FIG. 5B, at the point in which connecting bolt 10 slides along the path of the machined ramp 13, reaches the end if the slot, the component arm 2 and component back 1 will essentially bring together with no space between the 2 said components.

Thus the chair back and arm is securely attached together at a height above the bottom connecting point in a typical arm to back connection. Once the connection of the arm is made at this bottom arm to back connection and also to the front seat portion by means illustrated in FIG. 1, thus providing a very strong 3 point rectangle path of connection points, with no visible signs of the connections or connectors.

1. A method for fastening together ready to assemble modular components.
A. Where one side of said component has a projected said bolt which is screwed into said material of said component. The screwed in angle of degree of said bolt matches the same degree of angle of the said machined ramp of opposite said component. Whereby the said opposite component has keyhole slot to accept said bolt. The said hole of keyhole slot is correctly sized for said bolt head to pass through. The key slot of said opposite component is correctly sized to the diameter of said bolt shaft to enable the bolt to slide along said key slot. The degree of angle of said machined ramp inside half of said opposite component is machined to accept the under side of said bolt head. The degree of angle of machined ramp of said opposite component is angled inward. The machining of said angled machined ramp nearest the said hole of keyhole slot, starts at a minimum thickness for the bottom of the head of said bolt to rest in said ramp of said keyhole slot. The said angle of degree of said ramp in said keyhole slot changes in thickness, to a greater thickness as the said machined ramp follows the path of the said keyhole slot. The degree of angle of said machined ramp by way of the said bottom of bolt head sliding along from the thinner to the thicker section of said machined ramp in said keyhole slot. This action brings the head of the said bolt further into the said keyhole slot, resulting in the two said components being pulled together.
B. The said bolt is machined treaded into the said material of said component can be turned in a clockwise direction or counter clockwise direction, whereby creating a shorter or greater distance between the bottom of head of said bolt to the outer surface of the said component. The resulting change in said distance, accommodates for different thicknesses of covered materials around the said component and opposite connecting said component.
